(19) United States
(12) Patent Application Publication
(10) Pub. No.: US 2010/0162731 A1
(43) Pub. Date: Jul. 1, 2010

(54) CRYOGENIC COOLING APPARATUS AND METHOD USING A SLEEVE WITH HEAT TRANSFER MEMBER

(75) Inventor: Paul NOONAN, Abington (GB)

Correspondence Address: BLANK ROME LLP, WATERGATE, 600 NEW HAMPSHIRE AVENUE, N.W., WASHINGTON, DC, 20037, US

(73) Assignee: Oxford Instruments Superconductivity Limited, Abingdon (GB)

(21) Appl. No.: 12/564,495

(22) Filed: Sep. 22, 2009

(30) Foreign Application Priority Data
Sep. 22, 2008 (GB) 0817340.3

(51) Int. Cl. F17C 3/10

(52) U.S. Cl. 62/51.1; 62/48.2

(57) ABSTRACT

Cryogenic cooling apparatus comprises a chamber for containing coolant and a neck which opens into the chamber. A sleeve is provided which is located, when in use, within the neck. The apparatus includes a cooling element which is located exterior to the sleeve when the sleeve is in use. The sleeve comprises a heat transfer member adapted to cause the cooling element to remove heat from the interior of the sleeve through the use of heat transfer member.

### FIELD OF THE INVENTION

The present invention relates to a cryogenic cooling apparatus and method, particularly for use in cooling an insert which is inserted into a chamber of the apparatus through a neck when utilised with a sleeve.

### BACKGROUND TO THE INVENTION

In a conventional cryostat a chamber contains cryogenic coolant for cooling various apparatus within the chamber. A neck extends upwards from the chamber and provides access to the chamber from the external environment. An insert which includes target apparatus to be cooled is inserted along the neck and remains positioned within the neck during use. The insert therefore has one end immersed in the cryogenic coolant and the other substantially at ambient temperature. In practice this causes a significant heat input into the cryogenic coolant although this is substantially less than might be predicted since the coolant which is boiled off from the pool of coolant travels up the neck and performs heat exchange with the insert before venting from the top of the neck. Thus, the majority of the heat entering the insert never reaches the low temperature end since it is removed by the gaseous coolant.

Relatively recently cryostats have been developed which recycle the coolant evaporating from the chamber by recondensing the coolant and returning it to the chamber. Such recondensing dewars are beneficial for the preservation of coolant although potential problems are encountered regarding heat exchange with the insert since there is not a general flow of gaseous coolant up the neck from the chamber to the external environment. In practice it has been found that the cooling of a collar within the neck at a temperature of around 50 K provides sufficient cooling of the insert by a process of setting up convection currents within the neck.

During the introduction or removal of the insert from the cryostat a fibre glass sleeve is typically used to reduce the ingress of air from the external environment into the cryostat. The sleeve is elongate and takes the general form of a tube having a length of similar order as the insert. Such air ingress is problematical since it contains moisture which deposits as ice inside the cryostat and also since the warm air causes increased boil off of coolant. On introduction of the insert into the cryostat large volumes of cold helium gas are produced because a warm object is being inserted into a cold cryostat. The sleeve has the further benefit of channelling this cold helium gas over the insert thereby increasing the cooling efficiency. The use of a sleeve does not cause a problem in conventional cryostats where the insert is cooled by a flow of coolant gas up the neck. However, in a recondensing system the sleeve acts as a barrier which disrupts the convective coolant flow caused by the cooled collar. It would therefore be desirable to improve the cooling effect when the sleeve is in position whilst retaining the known advantages of the sleeve.

### SUMMARY OF THE INVENTION

In accordance with the first aspect of the present invention we provide a cryogenic cooling apparatus comprising a chamber for containing coolant, a neck which opens into the chamber, a sleeve located in use within the neck, a cooling element located exterior to the sleeve and wherein the sleeve further comprises a heat transfer member adapted to cause the cooling element to remove heat from the interior of the sleeve through the use of the heat transfer member.

We have realised that the problems caused by using a sleeve in a cooling system can be addressed by utilising a heat transfer member within the previously known “sleeve”. The heat transfer member applies the cooling power of the cooling element to the insert so as to prevent a significant quantity of coolant from being lost.

The heat transfer member may be adapted to remove heat from an insert positioned within the sleeve by forming at least a first convection current between the heat transfer member and the insert. The insert is adapted to support an experimental apparatus or object that requires cooling. In this case the convection current is created between the heat transfer member and the insert due to the difference in temperature between the insert (higher temperature) and the heat transfer member (lower temperature). This then allows the convection current to remove heat from the insert by the heat transfer member acting as a heat sink.

Preferably, in this arrangement the cooling element removes heat from the heat transfer member by forming at least a second convection current between the cooling element and the heat transfer member. The cooling element is held at an appropriate temperature and the second convection current is formed because of a temperature difference between the cooling element (lower temperature) and the heat transfer member (higher temperature). This allows the heat to be removed from the heat transfer member and transferred to the cooling element. Thus, cooling power from a refrigeration system is typically applied to the cooling element whereas the effective cooling power of the heat transfer member is provided by the cooling element.

Preferably, in this case the heat transfer member comprises a collar located within the sleeve. The collar may completely encircle the sleeve (and therefore the insert) and is joined to an upper and lower part of the sleeve by using a suitable adhesive. The collar is mounted to the respective parts by using a machined “ridge” in the end of each part so that the collar is flush with the walls of the sleeve. Other methods of joining annular sections together can also be utilised. It is also possible for the collar to be made in a number of fragments which either do not completely encircle the insert or are spaced circumferentially at regular or irregular intervals around the sleeve axis.

Typically, the heat transfer member comprises a first surface located on the interior of the sleeve and a second surface located on the exterior of the sleeve. To ensure efficient heat transfer, the collar preferably forms the entire cross section of the sleeve. Typically the heat transfer member will be flush with the interior and exterior surfaces of the sleeve however if required the heat transfer member can project outwardly or inwardly from the sleeve. The interior of the heat transfer member is positioned adjacent to the insert to be cooled and the exterior surface is adjacent to the surface of the neck.

Typically, the cooling element comprises a collar located within the neck. The cooling element preferably forms part of the neck, however other arrangements are possible.

Preferably, the cooling element comprises a first surface located on the interior of the neck and a second surface located exterior to the neck. The first (interior) surface can be either flush or projecting from the interior surface of the neck and the second surface of the cooling element is thermally connected to a cooling device in order for the cooling element to achieve the desired temperature.

As an alternative to the heat transfer member taking the form of a collar, the heat transfer member may comprise one or more apertures in which case the apparatus is adapted to form a third convection current between the cooling element and the insert positioned within the sleeve through the said one or more apertures. The apertures can be arranged in many shapes and sizes although typically they will be of approximately the same axial dimension as the cooling element. The apertures can be equally positioned circumferentially around the sleeve at a corresponding position opposite the cooling element. However, this is not a requirement. The third convection current is created through the aperture(s) due to the temperature difference between the insert (higher temperature) and the cooling element (lower temperature) and this convection current removes heat from the insert and transfers it to the cooling element through the aperture(s). The third convection current therefore performs a similar function to the combined effect of the first and second convection currents in the case of the “collar” heat transfer member.

Typically, the heat transfer member is constructed from a material with a high thermal conductivity. A material with a high thermal conductivity is used to increase the heat transfer from the insert to the cooling element and typically this will be formed from a metal such as copper or aluminium or other such material with a high thermal conductivity. This is particularly the case where a collar is used as the heat transfer member. Where apertures are used, these may be cut from a region of the sleeve material such as fibre glass. In this case a single piece sleeve may be used. A combination of the two types of heat transfer member is also envisaged such as a high thermal conductivity collar having apertures in which case the first, second and third convection currents may co-exist in use.

Preferably, the sleeve is constructed from a material with low thermal conductivity. This is a requirement to prevent heat transfer down the neck from the higher ambient temperature at the upper end of the neck to the coolant which is at a much lower temperature. An example material is fibre glass although any other material with a low thermal conductivity that is not affected by cryogenic temperatures could be used.

Preferably, the cooling element is constructed from a material with a high thermal conductivity. Preferably this will be a metal such as copper or aluminium as this increases the heat transfer from the cooling device to the cooling element and a material with a high thermal conductivity will better retain the desired temperature.

Preferably, the cooling element is separated from the sleeve by a gap. Typically the diameter of the sleeve will be approximately half the diameter of the neck.

Preferably, the cooling element is cooled by a cooling device in the form of a pulse tube refrigerator. Other cooling devices that could be used to cool the cooling element include mechanical refrigerators (such as a GM cooler) or other cooling systems. These cooling devices may comprise one or more cooled stages with each stage being at a respective operational temperature, one of which can be used to cool the cooling element.

Typically, the cooling element has an operational temperature of about 50 Kelvin. Other temperatures can also be used which are intermediate between the ambient temperature and the coolant temperature in the chamber, this being somewhat dependent upon the apparatus used and the cooling power available at that temperature.

Preferably, the coolant is an isotope of helium. For example, the coolant could be helium-3 or helium-4. Another possibility is to use the cooling properties of liquid nitrogen instead of helium in some apparatus. The coolant is typically provided in liquid form when in use within the chamber and the coolant within the neck is in the gaseous phase.

In accordance with a second aspect of the present invention, we provide a method of cooling the interior of a cryogenic cooling apparatus, the apparatus comprising a chamber for containing coolant, a neck which opens into the chamber, a sleeve located in use within the neck, a cooling element located exterior to the sleeve and wherein the sleeve further comprises a heat transfer member adapted to cause the cooling element to remove heat from the interior of the sleeve through the use of the heat transfer member, the method comprising transferring heat from the interior of the sleeve to the heat transfer member by forming at least a first convection current and transferring the heat from the heat transfer member to the cooling element.

Preferably, at least one convection current transfers the heat from an insert positioned within the sleeve to the cooling element. Either one, two or three convection currents can be created to transfer heat from the insert of cooling elements depending on the structure and formation of the heat transfer member. These two possibilities will be further discussed in the accompanying figures and description.

Preferably, when the heat transfer member comprises one or more apertures, on either insertion and/or removal of the sleeve from the neck a hinged collar is used to surround the apertures to prevent coolant gas escaping through the apertures.

The hinged collar may have a single hinge to open and close around the sleeve. As the sleeve is inserted into the neck the collar is placed over the apertures and slides with the sleeve towards the neck. Once the collar is in contact with the outer surface of the neck the sleeve can continue sliding through the collar and once the apertures are within the neck the collar can be removed. The collar could also take the form of a cover or shield for the apertures or a rotatable barrier which can slide around the sleeve to seal the apertures.

### BRIEF DESCRIPTION OF THE DRAWINGS

Some examples of an apparatus and method according to the invention are now described with reference to the accompanying drawings, in which:—

FIG. 1 is a schematic section through the cryogenic cooling apparatus when in use according to examples of the invention;

FIG. 2 is a first example of the invention;

FIG. 3 is a schematic section of the first example when in use;

FIG. 4 is a second example of the invention; and,

FIG. 5 is a schematic section of the second example when in use.

FIG. 6 is a flowchart of the first and second examples of the invention when in use.

### DESCRIPTION OF EXAMPLES

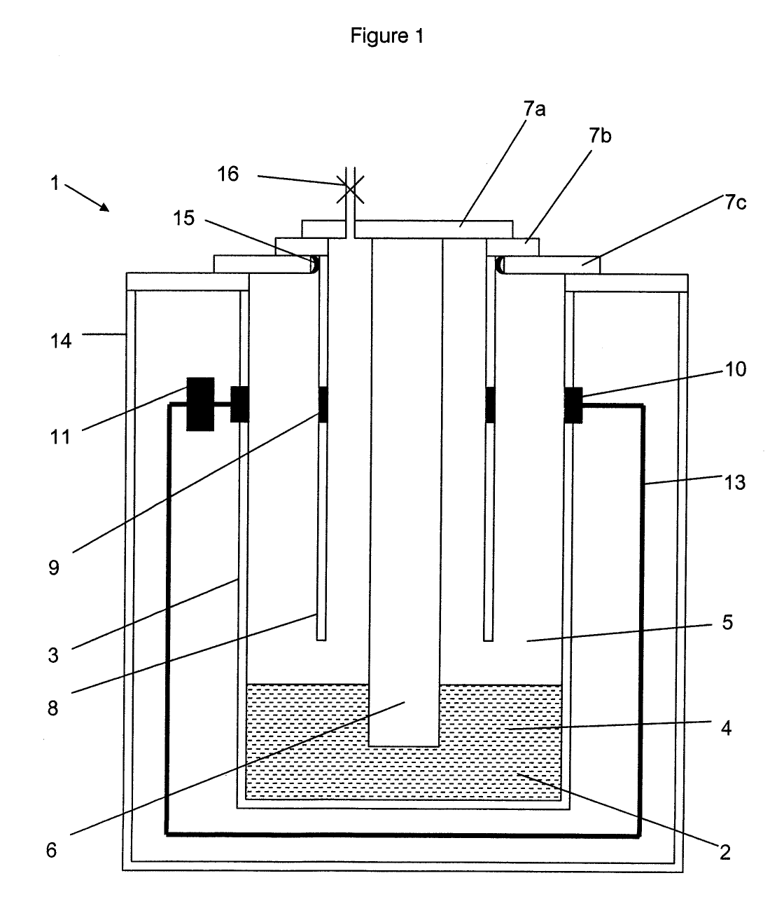

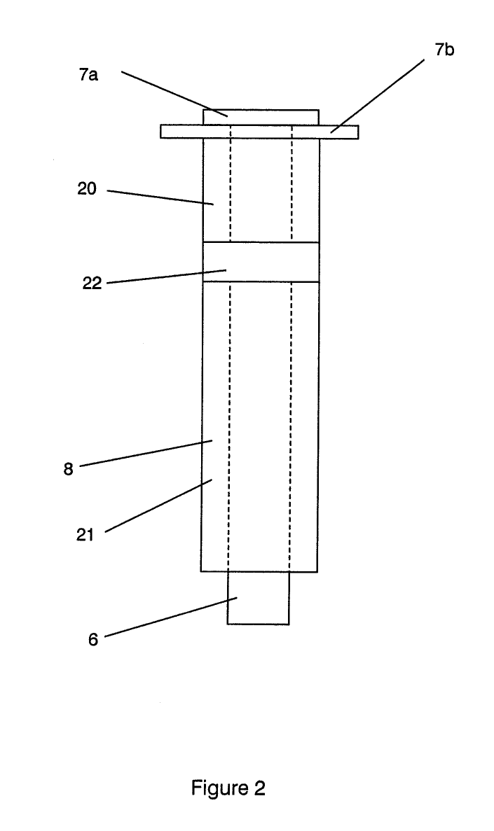

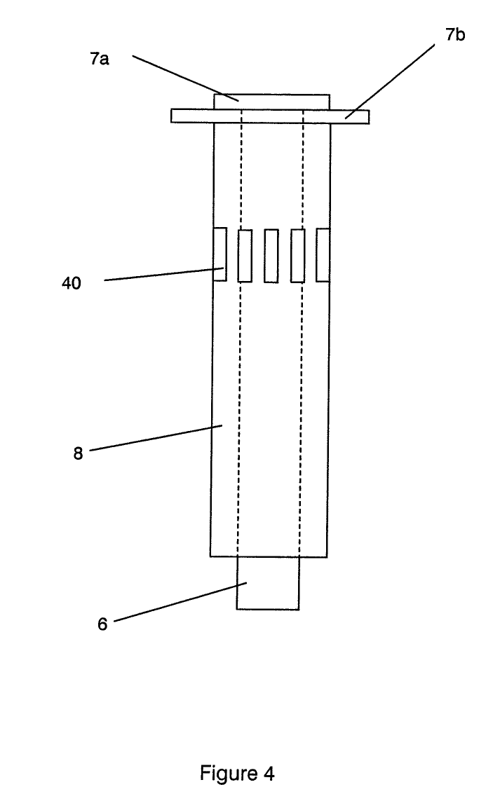

An apparatus according to the invention is shown in FIG. 1. The apparatus, generally indicated at 1, includes a recondensing dewar. This comprises a chamber 2 having an elongate neck 3 which opens into the interior of the chamber 2, and in use, takes the form of a hollow cylinder. As is shown in FIG. 1, the chamber 2 is partially filled with liquid coolant 4 when in use, in this case the coolant being in the form of liquid helium-4. Above the liquid coolant 4, there exists coolant in the gaseous phase as coolant gas 5. Also when in use, an insert 6 is provided within the neck 3. This insert can contain experimental equipment or apparatus which is required to be held at the temperature of the coolant 4. The neck 3 is sealed at an ambient temperature end of the neck by a number of removable flanges 7a, 7b and 7c. The flanges 7a, 7b and 7c together prevent any coolant gas 5 from escaping and being lost to the surrounding environment. Flange 7c supports one or more magnets (not shown) positioned within the cryostat. The flange 7c is removably attached to the cryostat to permit insertion and removal of the magnets as required. A cylindrical sleeve 8 is arranged to pass through the central bore of the flange 7c allowing it to be inserted or removed from the cryostat neck and chamber. The flange 7b is connected to the sleeve 8 and allows the sleeve 8 to be mounted to the cryostat, for example by coupling to flange 7c. Flange 7a is a flange connected to the insert 6. This allows for the insertion into and removal from the neck 3/chamber 2 of the insert 6 through a bore in the flange 7b. In use the flange 7a and insert 6 can be mounted to the cryostat, for example via the flange 7b. When mounted, the flange 7a seals the interior of the cryostat from the external environment. The sleeve 8 surrounds the insert 6 and extends part way down the neck but does not necessarily enter the liquid coolant 4. The sleeve 8 is constructed from a material with low thermal conductivity such as fibre glass. At a position closer to the ambient temperature (upper) end of the sleeve than the low temperature (lower) end a heat transfer member 9 is located. This heat transfer member 9 can take various forms such as being constructed from a material of high thermal conductivity or having a series of apertures within the sleeve (this will be discussed further in FIGS. 2 and 4). Within the neck 3 and at the same vertical position as the heat transfer member is a cooling element 10. This is formed as a collar within the neck 3 and has an internal surface in the neck 3 and an external surface which is thermally connected to the first stage of a pulse tube refrigerator (PTR) 11. The pulse tube refrigerator 11 cools the cooling element 10 to a temperature of approximately 50 Kelvin and this enables heat to be conducted away from the insert 6 by the heat transfer member 9 to the cooling element 10. The cooling element 10 is made from a material with a high conductivity such as copper and the neck 3 is made from a material with low thermal conductivity such as fibre glass or thin stainless steel in order to minimise conduction of heat down the neck from the flanges 7a, 7b and 7c. One of the flanges 7a, 7b, 7c may also be provided with a pressure valve to release the coolant gas 5 in the event of a malfunction. Such a malfunction may be the “quenching” of a magnet within the chamber that causes the majority of the coolant to evaporate in a short time period. The entire apparatus is surrounded by a radiation shield 13, which further minimises the heat lost from the system, and an outer vacuum case 14. Conveniently the radiation shields may be held at a similar temperature as the cooling element 10 by also thermally coupling them to the first stage of the PTR.

The apparatus 1 is a recondensing dewar which has minimal net gas flow from the liquid coolant 4 up the neck 3. Without gas flow providing heat exchange there is the potential for significant heat flow along the insert into the chamber. The present invention addresses this in that the recondensing dewar uses the cooling element 10 at approximately 50 K to create a convection current due to the difference in temperature between the cooling element and insert 6 so as to cool the insert. Despite the disruptive presence of the sleeve the heat transfer member allows convection currents to be generated thereby improving the cooling of the insert 6. The convection currents cool the region of the insert 6 in the vicinity of the cooling element 10 to approximately 50 K to reduce the heat flow down the insert 6/neck 3 and this reduces the amount of coolant lost. The cooling element 10 has about 40 W of cooling power to maintain its temperature at 50 K. If more than this amount of power is required to maintain the temperature then the temperature of the cooling element 10 will increase. In practice sufficient power is typically available to also cool the radiation shield 13. A PTFE (poly-tetra-fluoro-ethylene) seal 15 is used to ensure a near-gas-tight seal between the opening of the neck 3 and the sleeve 8 and reduce the evaporated coolant that escapes to the surrounding environment. This evaporated coolant is exhausted from the top of the insert via valve 16.

The sleeve 8 and heat transfer member 9 will be further described in FIGS. 2 to 5.

FIG. 2 illustrates a first example of a sleeve constructed from fibre glass. In this example, the heat transfer member 9 is constructed from a copper ring 22. This ring 22 is inserted in between an upper end 20 and a lower end 21 of the fibre glass sleeve 8. The copper ring 22 is formed as a collar within the sleeve. The sleeve is positioned between the neck 3 walls and the insert 6.

The copper ring 22 is formed as a collar and each of the interior and exterior surfaces are flush with the interior and exterior surfaces of the fibre glass sleeve 8. In order to ensure a tight seal between the copper ring 22 and the fibre glass sleeve 8 a ridge is cut into the adjoining regions of the fibre glass sleeve 8 and copper ring 22 and an appropriate adhesive is used to ensure a tight seal is maintained between the separate components.

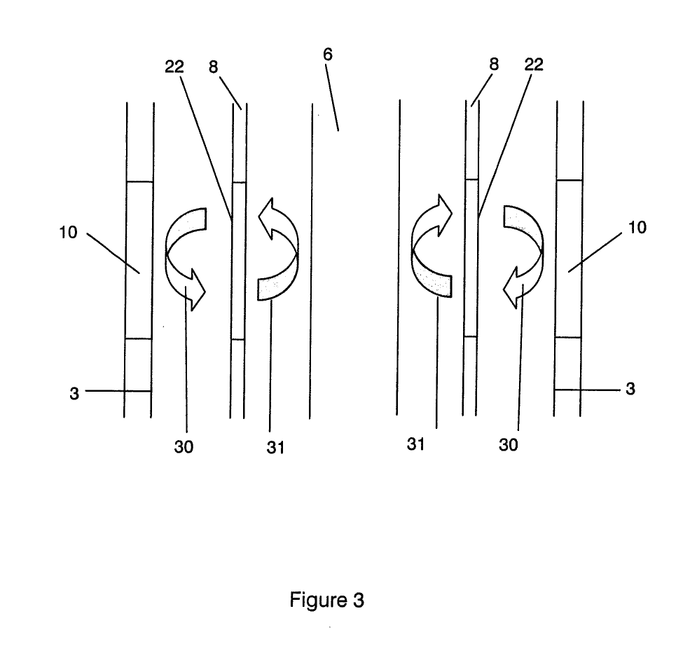

FIG. 3 is a schematic view partly in section which illustrates how the copper ring 22 (of FIG. 2) in combination with the cooling element 10 allows heat to be removed from the insert. The cooling element 10 is held at a temperature of approximately 50 K by the first stage of a two stage pulse tube refrigerator 11. The coolant gas 5 within the neck of the apparatus exhibits a temperature gradient such that the coolant gas temperature increases as a function of distance above the liquid coolant 4. The heat transfer member in the form of the copper ring is arranged at a position which is adjacent (opposite) the cooling element 10 when the sleeve is correctly inserted into the cryostat. In practice the copper ring is positioned about 70% of the distance along the length of the sleeve from the lower (cold) end when in use. At the vertical position of the cooling element 10 the temperature of the coolant gas is in excess of that of the cooling element 10 (50 K). The gas cooled by the cooling element 10 sinks and is replaced by warmer coolant gas 5 adjacent to copper ring 22. The warmer coolant gas adjacent to copper ring 22 is replaced by the sinking cooler gas. This cooler gas is warmed by contact with copper ring 22 and thus convection current 30 is set up. This convection current removes heat from the copper ring 22 and causes it to maintain a temperature slightly above the temperature of cooling element 10. Consequently, the copper ring 22 is held at a lower temperature than the adjacent part of the insert 6. The difference in temperature between the copper ring 22 and the insert 6 creates a second convection current 31. This causes heat from the insert to be removed by the convection current 31 and transferred to the copper ring 22. Then the first convection current 30 transfers this heat from the copper ring 22 to the cooling element 10. This removal of heat from the insert 6 via the copper ring 22 allows the portion of the insert approximately adjacent to the heat transfer member 9 to maintain a temperature only slightly in excess of cooling element 10. This reduces the temperature gradient along the insert between the cooled region and the lower end within the liquid coolant 4. This in turn reduces the flow of heat from the upper end of the insert to the lower end and thereby reduces the amount of gaseous coolant 5 lost to the surrounding environment.

FIG. 4 illustrates a second example of a sleeve. In this example the heat transfer member 9 is formed as a series of apertures 40 located around the circumference of the sleeve 8. In this case a single piece sleeve is used, again formed from fibre glass. The apertures 40 are approximately uniform in shape and size and are created in the fibre glass sleeve using a precision cutter.

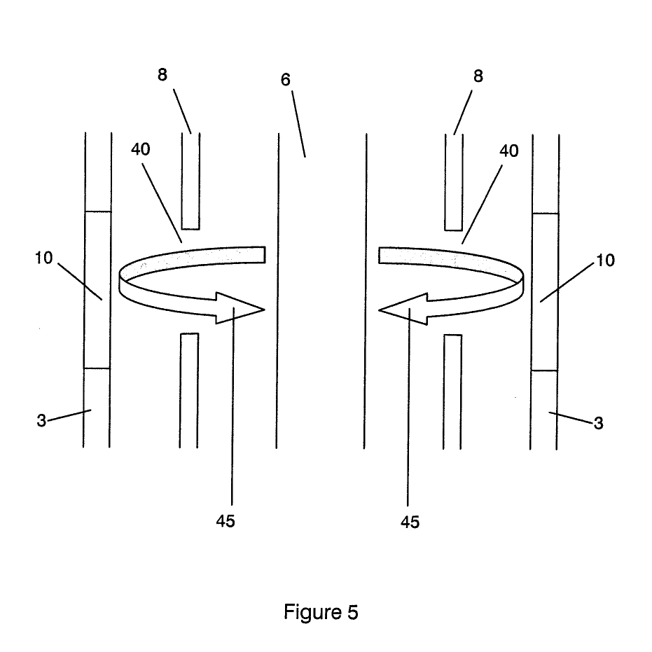

FIG. 5 illustrates how the use of the apertures 40 removes heat from the insert 6 and cools it to a temperature approaching that of the cooling element 10. As previously described with FIG. 3 the sleeve is located between the insert 6 and the neck 3. The cooling element 10 is thermally connected to a pulse tube refrigerator 11 and has a temperature of approximately 50 Kelvin. The difference in temperature between the insert 6 and the cooling element 10 allows convection current 45 to be created between these two regions. In this case the convection current passes through the apertures 40. In contrast to the example described in FIG. 3 only a single convection current is created between the cooling element 10 and the insert 6. The combination of the higher temperature gas surrounding the insert 6 and the lower temperature gas surrounding the cooling element 10 creates the convection current and allows heat to be removed from the insert 6 and transferred to the cooling element 10. This as described previously with reference to FIG. 3 reduces the temperature of the insert in the region of the cooling element 10 and apertures 40 and reduces the temperature gradient in the lower part of the insert 6 between the apertures 40 and the liquid coolant 4 in the chamber 2.

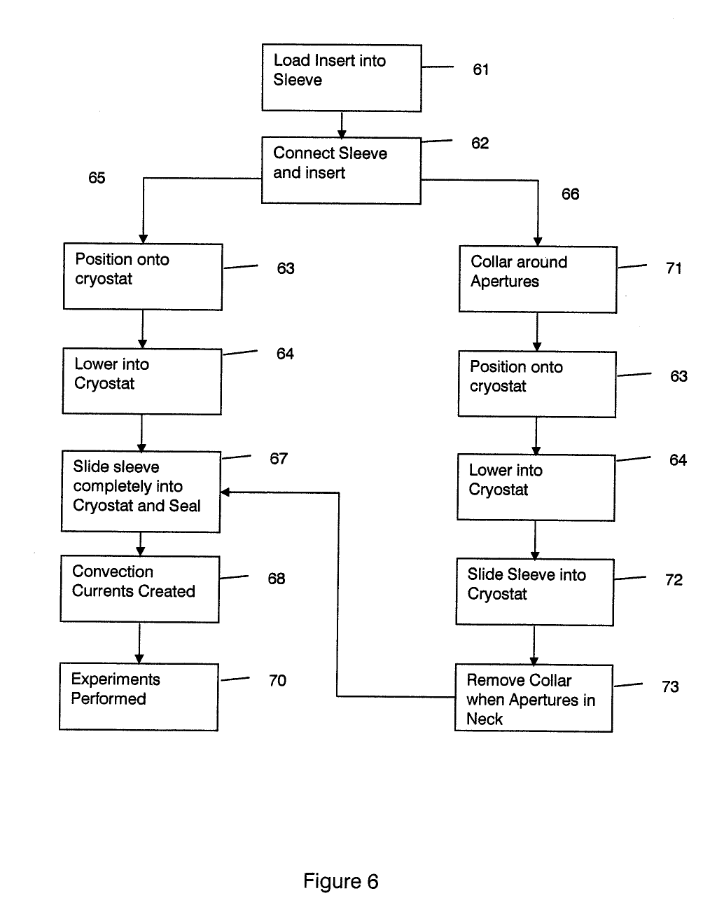

The sleeve is inserted and removed from the cryostat in a manner that minimises the loss of the cryogenic coolant and also air ingress. This procedure will now be described in more detail with reference to FIG. 6. Initially at step 61 the insert 6 to be cooled is loaded into the fibre glass sleeve 8. The sleeve and the insert (and corresponding flanges 7a and 7b) are bolted together to ensure that they act as a single unit at step 62. At this point in the process two different methods can be adapted depending on which example heat transfer member 10 is in use. If the copper ring heat transfer member 22 is utilised then method 65 is used and if the aperture heat transfer member 40 is utilised then method 66 is used. When method 65 is used, the cryostat is first prepared for insertion of the insert and sleeve. The sleeve 8 and insert 6 are mounted to a crane, positioned onto the cryostat (step 63) and are slowly lowered into the chamber 2 through the neck 3 at step 64. At step 67 the insert and sleeve unit are slowly lowered into the chamber 2 until they are completely within the cryostat. The lowering of the sleeve 8 and insert 6 into the cryostat causes helium coolant to be boiled off from the chamber due to the heat input. This is vented through the valve 16. A PTFE (poly-tetra-fluoro-ethylene) seal 15 is used to ensure a near-gas-tight seal between the opening of the neck 3 and the sleeve 8 and reduce the evaporated coolant that escapes to the surrounding environment during normal use. Any coolant which boils off whilst the sleeve and insert are being lowered into position passes up the inside of the sleeve and around the insert 6 which therefore cools the insert. The insert and sleeve attain an operational position within the neck/chamber and the valve 16 is closed to seal the opening to the sleeve.

At step 68 the collar heat transfer member 22 in the sleeve 8 lies approximately adjacent to the cooling element 10 within the neck 3. This allows the convection currents described with respect to FIG. 3 to be set up and cool the region of the insert adjacent to the heat transfer member to a temperature that is only slightly in excess of that of cooling element 10. The convection currents reduce the heat load reaching the liquid coolant 4 within the chamber 2 from the flanges 7a, 7b, 7c and in particular from the ambient temperature end of the insert. The PTFE seal 15 also ensures minimal gas escape from the chamber 2.

At step 70 the insert is operated according to its intended function such as in the performance of experiments. It should be noted that the insert is operated with the sleeve in place and there is no time limitation in principle on the amount of time that it can be left in position.

If the heat transfer member takes the form of apertures 40 and method 66 is used then after the sleeve and insert have been connected together (step 62), a hinged split collar is placed around the apertures (step 71) to cover them whilst the sleeve is being inserted into the chamber to prevent coolant gas from escaping through the apertures 40. The sleeve and insert are positioned onto the cryostat (step 63), lowered into the cryostat (step 64) and are slid into position in the chamber (step 72) as previously described. The collar cannot enter the cryostat as it has a larger diameter than the opening of the neck 3 and slides up the sleeve 8. When the apertures are completely inside the neck 3 the split collar can be removed (step 73) and the sleeve and insert are slid completely into the cryostat as described previously in step 67. The PTFE 15 seal as previously described with respect to method 65 is also utilised so that the seal between the neck and sleeve is as gas-tight as possible. It will be appreciated that the cooling of the insert and sleeve by the evaporated coolant and the exhaustion of the helium gas by valve 16 occurs as previously described with respect to method 65. At step 68 as described with respect to method 65 the aperture heat transfer member is approximately adjacent to the cooling element, the convection currents described with respect to FIG. 5 are created and reduce the heat transfer along the insert as previously described with respect to method 65. Step 70 can then be performed as described with the “collar” heat transfer member. It will also be appreciated that the steps of FIG. 6 can be reversed to remove the insert and sleeve.

In a practical example the neck 3 will have a diameter of approximately 25 cm and contain baffles (in the form of discs). The baffles do not disrupt the convection currents created between the insert and the cooling element since they are placed sufficiently distal from the position of the cooling element. The primary function of the baffles is to act as radiation shields to minimise radiated heat load down the neck onto the coolant reservoir beneath. The sleeve 8 has a diameter of approximately 18 cm in this case and the insert diameter can be any size ranging from the order of a centimetre to almost the diameter of the sleeve. The insert can also comprise baffles to reduce the heat transfer down the insert and these can be arranged to have a diameter a few millimetres less than that of the sleeve. A great advantage of the invention is that the diameter of the insert is able to be varied greatly as the convection currents are able to perform the cooling action over a wide ranging gap size between the insert and the sleeve diameter. However, the use of the convection currents to cool the insert is more effective if the gap between the heat transfer member and the insert is as small as possible. The primary advantage of the sleeve being able to function with any sized insert is that the insert does not need to be modified and any suitable conventional insert and apparatus can be used. Thus a retro-fit function is provided.

1. Cryogenic cooling apparatus comprising:—
a chamber for containing coolant;
a neck which opens into the chamber;
a sleeve located in use within the neck;
a cooling element located exterior to the sleeve; and
wherein the sleeve further comprises a heat transfer member adapted to cause the cooling element to remove heat from the interior of the sleeve through the use of the heat transfer member.

2. Apparatus according to claim 1, wherein in use the heat transfer member is adapted to remove heat from an insert positioned within the sleeve by forming at least a first convection current between the heat transfer member and the insert.

3. Apparatus according to claim 1 or claim 2, wherein the cooling element removes heat from the heat transfer member by forming at least a second convection current between the cooling element and the heat transfer member.

4. Apparatus according to any of the preceding claims, wherein the heat transfer member comprises a collar located within the sleeve.

5. Apparatus according to claim 4, wherein the heat transfer member comprises a first surface located on the interior of the sleeve and a second surface located on the exterior of the sleeve.

6. Apparatus according to claim 1, wherein the cooling element comprises a collar located within the neck.

7. Apparatus according to claim 6, wherein the cooling element comprises a first surface located on the interior of the neck and a second surface located exterior to the neck.

8. Apparatus according to claim 1, wherein the heat transfer member comprises one or more apertures and wherein the apparatus is adapted to form a third convection current between the cooling element and an insert positioned within the sleeve through the said one or more apertures.

9. Apparatus according to any of the preceding claims, wherein the heat transfer member is constructed from a material with a high thermal conductivity.

10. Apparatus according to claim 1, wherein the sleeve is constructed from a material with a low thermal conductivity.

11. Apparatus according to any of the preceding claims, wherein the cooling element is constructed from a material with a high thermal conductivity.

12. Apparatus according to any of the preceding claims, wherein the cooling element is separated from the sleeve by a gap.

13. Apparatus according to any of the preceding claims, wherein the cooling element is cooled by a pulse tube refrigerator.

14. Apparatus according to any of the preceding claims, wherein the cooling element has a temperature of about 50 K.

15. Apparatus according to any of the preceding claims, wherein the coolant is an isotope of helium.

16. A method of cooling the interior of a cryogenic cooling apparatus, the apparatus comprising:—
a chamber for containing coolant;
a neck which opens into the chamber;
a sleeve located in use within the neck;
a cooling element located exterior to the sleeve; and
wherein the sleeve further comprises a heat transfer member adapted to cause the cooling element to remove heat from the interior of the sleeve through the use of the heat transfer member the method comprising:—
transferring heat from the interior of the sleeve to the heat transfer member by forming at least a first convection current; and
transferring the heat from the heat transfer member to the cooling element.

17. A method according to claim 16, wherein at least one convection current transfers the heat from an insert positioned within the sleeve to the cooling element.

18. A method according to either of claim 16 or 17, wherein when the heat transfer member comprises one or more apertures, upon either insertion and/or removal of the sleeve from the neck a hinged collar is used to surround the apertures to prevent coolant gas escaping through the apertures.
